(19) United States
(12) Patent Application Publication
(10) Pub. No.: US 2004/0215698 A1
(43) Pub. Date: Oct. 28, 2004

(54) Method of delivering content to destination terminals and collection server

(76) Inventor: Christian Bertin, Rennes (FR)

Correspondence Address: Thomas Langer, Cohen Pontani Lieberman & Pavane, Suite 1210, 551 Fifth Avenue, New York, NY, 10176, US

(21) Appl. No.: 10/483,798

(22) PCT Filed: Jul. 2, 2002
(86) PCT No.: PCT/FR02/02293

(30) Foreign Application Priority Data
Jul. 13, 2001 (FR) 01 09438

(51) Int. Cl. G06F 15/16

(52) U.S. Cl. 709/201

(57) ABSTRACT

Each terminal (Ti) recovers descriptive data associated with the source (S), into which an address of a collection server (SC) is inserted. The source (S) broadcasts the content over a network, and each receiver terminal (Ti) acquires the broadcast content, using said descriptive data, and signals to the address of the collection server (SC) that it is receiving from the source (S) by sending an audience report by said source (S).

The present invention relates to a method of broadcasting a content in real-time from a source to a plurality of receiver terminals via a computer network, for example the Internet.

The Internet can broadcast multimedia content such as TV broadcasts, video films, conferences, and other programs, in real time to a large audience of receiver terminals. There are two main methods for broadcasting data in real-time from one source to a plurality of receiver terminals via the Internet.

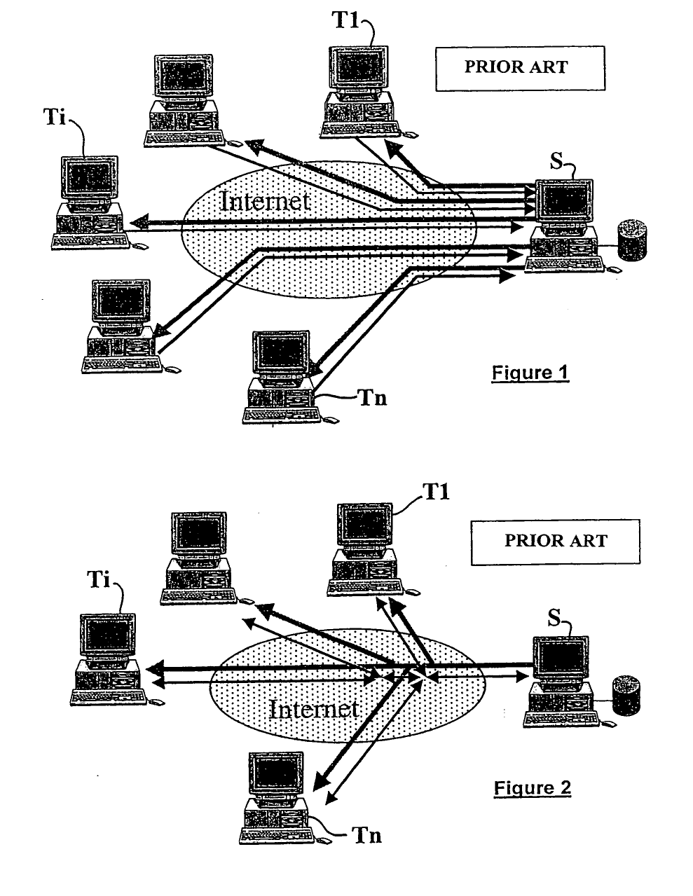

Referring to FIG. 1, the first of these methods is the “unicast” method, which consists in sending the same content as many times as there are receiver terminals T1, . . . , Ti, . . . , Tn. The source S sets up a point-to-point connection with each of the receiver terminals, divides the content to be broadcast into IP data packets, also known as “datagrams”, duplicates each IP datagram to obtain n copies, where n is the number of receiver terminals Ti, and sends the n copies to the n receiver terminals T1, . . . , Ti, . . . , Tn respectively.

Referring to FIG. 2, the second method is the “multicast” method and enables the source S to broadcast a multimedia content to a plurality of receiver terminals T1, . . . , Ti, . . . , Tn in one sending. During the broadcasting of the content, the source S sends IP datagrams that are duplicated cascade fashion by the nodes of the network, which are referred to hereinafter as “routers”, and then routed to the receiver terminals T1, . . . , Ti, . . . , Tn. If none of the terminals Ti requests to receive the data packets sent by the source, the latter are not routed beyond the first node of the network and are therefore lost. If a terminal Ti wishes to receive the multimedia content broadcast by the source S, it sends a request to acquire that content to the source S via the Internet using the Internet Group Management Protocol (IGMP). The first multicast router that receives the request and that is already receiving the IP datagrams broadcast by the source then duplicates the IP datagrams and routes them to the terminal Ti or to another router. The expression “multicast router” refers to a node of the network which receives datagrams broadcast by the source and routes them to one or more terminals, possibly after duplicating them.

To receive a multimedia content broadcast by a source in unicast mode or in multicast mode, each receiver terminal must first recover a Session Description Protocol (SDP) descriptive file associated with the source, for example by downloading it from a website. The structure of the SDP file is defined by the Internet Engineering Task Force (IETF) in the document RFC 2327. This file is intended to convey the information required for the receiver terminals to be able to receive the multimedia content broadcast by the source. To each source there corresponds a general SDP file containing all the information required to receive from the source, regardless of the content it broadcasts. To each content that is broadcast (TV transmission, film, conference, etc.) there corresponds a specific SDP file containing all the information needed to receive that particular content. The general SDP file for the source is valid regardless of the content broadcast by the source but the SDP file for a specific content is valid only for the broadcasting of that content.

The data transmission protocol essentially used for real-time unicast or multicast broadcasting via the Internet is the Real-Time Transfer Protocol (RTP). It is usually associated with the Real-Time Transfer Control Protocol (RTCP) for controlling data streams and enabling receiver terminals to feed reception reports back to the source, which reports contain quality of service (QoS) information on reception quality, such as an indication of the bit rate at which the broadcast is received and the rate of loss of datagrams. Under the RTP, to broadcast a multimedia content, the source sends a plurality of data streams, each stream conveying data corresponding to a specific one of the media. For example, to broadcast a video film in two languages, the source sends a video stream and two audio streams, one for each language. Also, the data of the same media, for example video data or audio data, can be carried by a plurality of streams having different data bit rates. For example, to broadcast the video component of an audiovisual content, the source can send three video streams, each at 400 kbit/s, consisting of a basic video stream Vb, a first video enhancement stream Ve1 (Video enhancement 1), and a second video enhancement stream Ve2 (Video enhancement 2). Depending on their capacity, the receiver terminals use the basic video stream and where applicable add to it the video stream Ve1 and/or the video stream Ve2 to enhance video quality.

Alternatively, the source can send three video streams at 400 kbit/s, 800 kbit/s and 1 200 kbit/s, respectively, the receiver terminals selecting only one of these three streams, according to their capacities. To receive a multimedia content conveyed by n streams, the receiver terminals use n pairs of communication ports each comprising an RTP port and an RTCP port to receive the n streams and to send n reception reports corresponding to the n streams. The RTP and RTCP communication ports associated with the same pair are in sequence, the RTP port having an even number and the RTCP port an odd number.

In the unicast mode, the source sets up as many point-to-point connections as there are receiver terminals. It is thus possible to measure without difficulty the audience of the source in real time by counting the point-to-point connections set up. However, the unicast technique is greedy in terms of bandwidth and is therefore unsuitable for broadcasting to a large public.

The multicast technique greatly reduces the amount of bandwidth used. However, there is no simple way to measure the audience of the source. The source sends its audiovisual content in a single operation without being able to count the receiving terminals.

The technical problem addressed by the present invention is therefore that of proposing a method of broadcasting a content from a source to a plurality of receiver terminals via a computer network and in real time, in which method each terminal recovers descriptive data associated with the source, the source broadcasts the content over the network, and the receiver terminals acquire the broadcast content, using said descriptive data, which enables the audience of the source to be measured.

The problem is solved in that the address of a collection server is inserted into said descriptive data and each receiver terminal signals that it is receiving from the broadcast source by sending an audience report to said address.

The present invention addresses a multicast broadcasting problem. However, the Applicant has no intention of limiting the scope of this application to that particular example, but instead to encompass any type of broadcasting, including unicast broadcasting.

In the prior art, the RTCP protocol enabled information to be fed back to the source. The immediate solution to the problem of the invention was therefore to use that protocol for measuring the multicast audience. The Applicant has however searched for a solution that is less immediate but more satisfactory. Separating the source and the audience report collector circumvents the drawbacks of the RTCP which, due to the fact that it is closely connected to the RTP protocol, feeds back a significant quantity of information to the source, especially in the case of broadcasting content conveyed via a plurality of streams, and the audience is measured in simple manner. The solution according to the present invention has the additional advantage of not overloading the source with feedback of audience reports. The source can therefore use all of its capabilities exclusively for broadcasting. Furthermore, because the address is inserted into the descriptive data associated with the source, the receiver terminal recovers it without having to take any specific action and without requiring any additional equipment.

Periodicity information is advantageously inserted into said descriptive data so that each receiver terminal can periodically send the collection server an audience report indicating that it is receiving from the broadcast source.

In a particular embodiment, the terminal inserts into the audience report a geographical location indication and/or a preferred language and/or information about reception quality. This makes it possible to draw up profiles of the receiver terminals, in other words know their receiving characteristics. Knowledge of said profiles enables a programming center to adapt the programming schedule of the source so as to target the receiver terminals more closely as a function of their profiles.

The collection server preferably assigns a time and a date to each audience report received. All the audience reports are thus assigned a time and date by the same clock.

The collection server advantageously responds to audience reports from the terminals, to produce a summary relating to the audience of the broadcast source indicating the number of terminals receiving from the broadcast source. In other words, the collection server measures the audience of the broadcast source by means of audience reports received from terminals receiving from the broadcast source, and thus produces a summary of said audience. The collection server could then transmit said summary to the programming center of the source, which could use it in order to adapt the programming schedule of the source.

Also preferably, a plurality of sources broadcast contents to a plurality of groups of receiver terminals and all the terminals belonging to the various groups send audience reports to the same collection server. The collection server can thus serve as an audience ratings center for a plurality of sources.

The descriptive data associated with the source can be inserted into an SDP file.

The address of the collection server can also be broadcast on a signaling channel associated with the source.

The invention also provides a collection server for implementing the above-defined method, the server comprising:

receiver means adapted to receive from receiver terminals audience reports concerning a broadcast source and indicating that said terminals are receiving from said broadcast source,

processor means adapted to respond to audience reports it receives, to produce a summary relating to the audience of said broadcast source and indicating the number of terminals receiving from said broadcast source, and

means for sending the audience summary to a programming center associated with said source.

The invention further provides a receiver terminal for implementing the above-defined method, the terminal being characterized in that it is adapted to recover descriptive data associated with a broadcast source and containing an address of a collection server and to send to the address of said collection server at least one audience report indicating that it is receiving from said broadcast source.

The invention further provides a system for implementing the above-defined method, the system comprising:

a broadcast source adapted to broadcast a content over a network,

a collection server, and

receiver terminals adapted to recover descriptive data associated with the broadcast source and containing an address of the collection server, to acquire the content broadcast by the broadcast source using the descriptive data, and to send to the address of the collection server audience reports indicating that the terminals are receiving from said broadcast source,

said collection server being adapted to produce a summary about the audience of said broadcast source, indicating the number of terminals receiving from said broadcast source.

Finally, the invention provides a descriptive data stream for implementing the above-defined method and containing information to enable a terminal to receive from a broadcast source, the data stream being characterized in that it contains information enabling a terminal to send to a collection server an audience report indicating that it is receiving from said broadcast source.

The present invention will be understood better from the following description of a particular implementation of a broadcasting method and of a particular embodiment of the collection server of the invention, which description is given with reference to the appended drawings, in which:

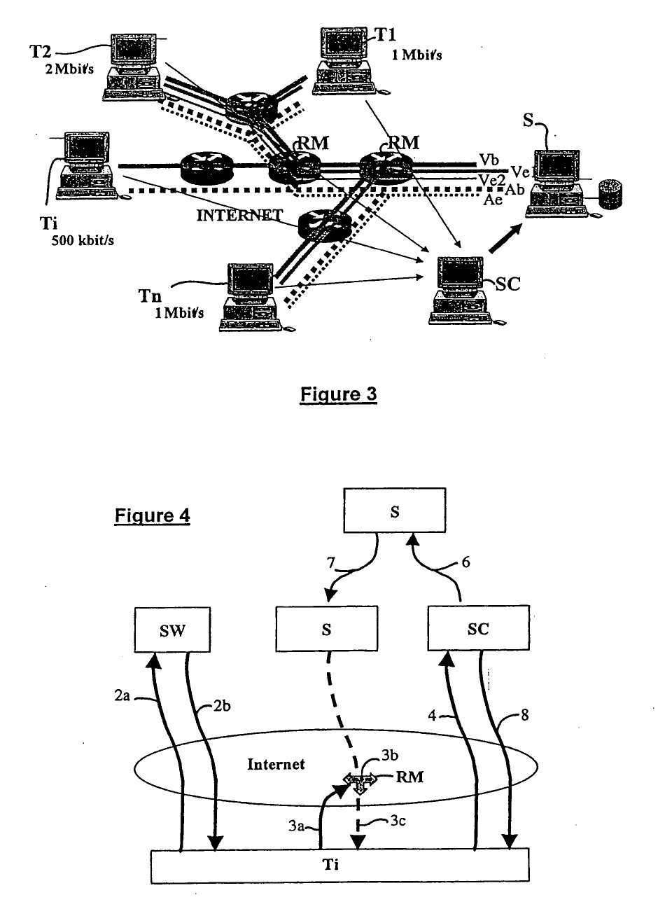

FIG. 3 is a diagram showing a plurality of receiver terminals, a broadcast source, a programming center, and a collection server,

FIG. 4 is a diagram showing one of the receiver terminals, the broadcast source and the collection server of FIG. 3, a website, and the various steps of a specific implementation of a broadcast method of the invention,

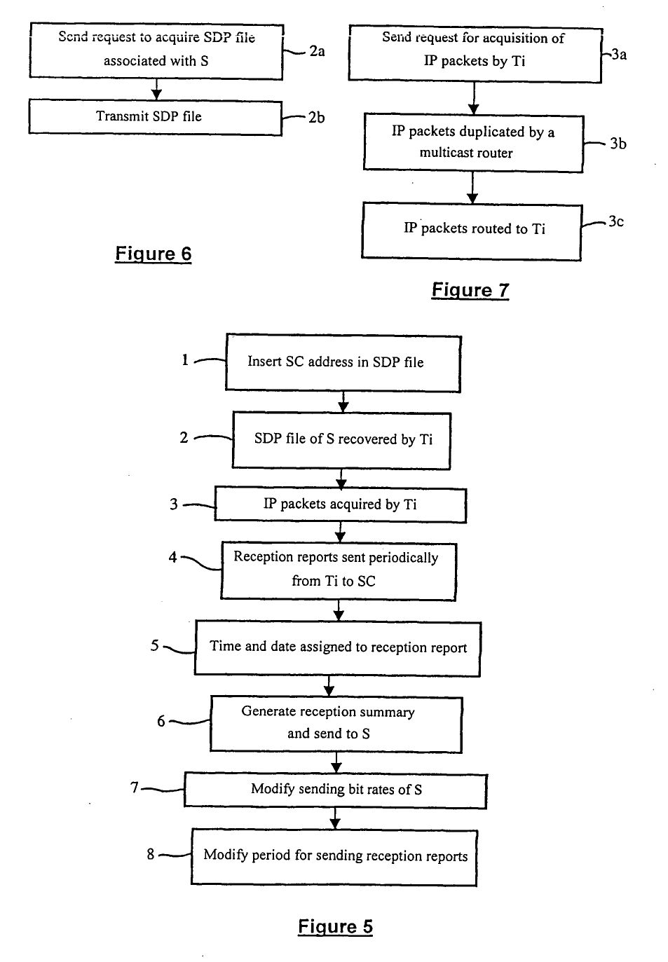

FIGS. 5 to 7 are flowcharts of the same specific implementation of a broadcast method of the invention, and

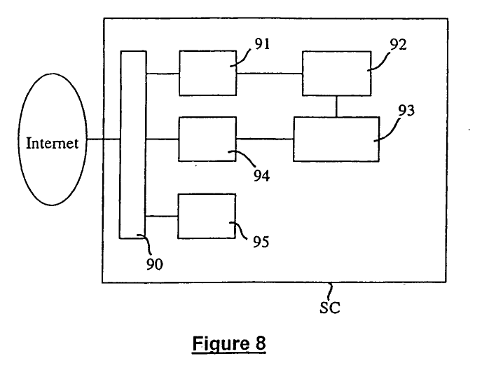

FIG. 8 is a block diagram of the FIG. 3 collection server.

FIG. 3 shows a computer network, in this instance the Internet, and a system comprising a plurality of terminals, T1, T2, . . . , Ti, . . . , Tn, a broadcast source S, a programming center CP, and a collection server SC. In the particular example of the description, the broadcast source S is an audiovisual broadcast channel, referred to hereinafter as “Chaine1”, hosted by an audiovisual Internet server and adapted to broadcast audiovisual content (TV transmissions, video films, etc.) to receiver terminals in multicast mode via the Internet. The audiovisual server could host other broadcast sources.

The programming center CP is adapted to establish a programming chart for the broadcasting of audiovisual content by the source S and to create for the source S a general descriptive SDP file containing all the information needed for a terminal to receive from the source S and, for each broadcast content, a specific descriptive SDP file containing all the information required to receive that content. The descriptive SDP files associated with the source S are transmitted to the website SW, from which they can be downloaded by the terminals.

Note that the structure of an SDP file, as defined by the IETF, is as follows:

Session description

v=(protocol version)

o=(owner/creator and session identifier)

s=(session name)

i=*(session information)

u=*(URL of description)

e=*(email address)

p=*(phone number)

c=*(connection information—not required if included in all media)

b=*(bandwidth information)

One or more time descriptions (see below)

z=*(time zone adjustments)

k=*(encryption key)

a=*(zero or more session attribute lines)

Zero or more media descriptions (see below)

Time Description

t=(time the session is active)

r=*(zero or more repeat lines)

Media Description

m=*(media name and transport address)

i=*(media title)

c=*(connection information—optional if included at session level)

b=*(bandwidth information)

k=*(encryption key)

a=*(zero or more attribute lines)

The fields marked “*” are optional.

For more information on the structure of SDP data, see the IETF document RFC 2327.

The collection server SC, which is connected to the Internet, collects audience reports relating to a broadcast source S, from receiver terminals Ti and indicating that said terminals are receiving from said source S. It includes an Internet interface 90, a report receiver unit 91, a unit 92 for timing and dating reports, a processor unit 93, a unit 94 for sending the summary to the source S, and a unit 95 for modifying the period for sending reports. All these units are connected to a central control unit, not shown, for controlling the operation of the server SC. The units 91, 94 and 95 are connected to the connection interface 90. The time and date unit 92 between the receiver unit 91 and the processor unit 93 times and dates the reports received. The processor unit 93, which is connected to the sender unit 94, is adapted to measure the audience of the broadcast source S, and is adapted to respond to audience reports from receiver terminals Ti, to produce a statistical summary relating to said audience of the broadcast source S. The audience summary comprises histograms indicating the numbers of terminals receiving from the broadcast source S in compliance with various parameters (e.g. the receiving time, the receiving language, the receiving location, etc.).

Each receiver terminal Ti includes an Internet connection module, an Internet browser, a multicast receiver module, a man-machine interface, and a central control unit to which all the units of the terminal are connected and which controls their operation. The man-machine interface includes a display screen, input means, (a keypad and a mouse), and a loudspeaker. The multicast receiver module is adapted to receive from a broadcast source S via the Internet and, during reception, to send audience reports to the collection server SC indicating in particular that the terminal Ti is receiving from the source S. In use, to receive from a broadcast source S, the receiver module cooperates with the Internet connection module and the Internet browser to recover descriptive data, in this case an SDP file, associated with the broadcast source S, and in this case by downloading it from the website SW. Using information contained in the SDP file, the receiver module receives from the source S, i.e. acquires the content broadcast thereby, and in parallel with this periodically sends via the Internet to the address of the collection server SC, extracted from the SDP file, audience reports indicating in particular that the terminal Ti is receiving from the broadcast source S.

The method of broadcasting an audiovisual content in real time from the source S to a plurality of terminals Ti via the Internet in multicast mode is described next with reference to FIGS. 4 to 7. In the specific example described here, the content broadcast is a video film entitled “La Grande Vadrouille”.

In a step 1, the programming center inserts a field, in this case “d” associated with the collection server SC into the specific SDP file of the content to be broadcast, namely the film “La Grande Vadrouille”, and into the general SDP file of the source S. The field “d”, which is defined below, contains all the information required for a receiver terminal Ti to send an audience report periodically to the collection server SC.

Field d

d=<network type><address type><connection address><port><time period>

The field “d”, which really constitutes a command to send audience reports to the server SC, contains an indication of the network to which the server SC belongs, the server SC address type, the server SC address, the server SC communication port number, and the period τ for sending reports to the server SC.

The SDP file of the source and the SDP file of the film are transmitted to the website SW and can be downloaded from that site by the terminals.

The SDP file of the film “La Grande Vadrouille” broadcast by Chaine1, contains the following information, for example:

v=0

o=channel1 IN IP4 126.16.64.4

s=La grande vadrouille

u=http://www.chaine1.fr/films/la_grande_vadrouille.htm

e=infos@chaine1.fr

c=IN IP4 224.2.17.12/127

t=2873397496 2873404696

a=recvonly

m=audio 49170 RTP/AVP 0

m=video 51372 RTP/AVP 31

m=application 32416 udp wb

d=IN IP4 224.2.1.1 32416 300

The field “d” indicates that:

the server SC is an Internet server;

the address of the server SC is an IP4 address;

the IP address of the server SC is 224.2.1.1;

the communication port number of the server SC is 32416, and

the period T for sending audience reports is 300 seconds.

In a step 2, each terminal Ti wishing to receive the film recovers a stream of descriptive data associated with the broadcast source S and carrying the specific SDP file for the film in question or the general SDP file for the source S. Remember that the SDP file for the film is valid only for the broadcasting of the film concerned, whereas the SDP file for the source enables reception from the source at any time, regardless of the content it is broadcasting. To receive the descriptive data stream carrying one of these two SDP files, in a step 2a, the terminal logs onto to the website SW and sends it a request to acquire the file in question. On receiving that request, in a step 2b, the website SW send the required file to the terminal Ti, which stores it.

The source S broadcasts the video film in multicast mode via the Internet. To do this, it sends IP data packets carrying the audiovisual content to a plurality of receiver terminals once and for all, via the Internet.

In a step 3, from information contained in the SDP file received, each terminal Ti wishing to receive the film acquires the IP data packets broadcast by the source S over the Internet. Step 3 comprises a number of substeps:

the terminal Ti sends a request to acquire the audiovisual content broadcast by the source S, namely the video film “La Grande Vadrouille”, to the source S, via the Internet, using the IGMP (step 3a),

the first multicast router RM that receives the request duplicates the IP packets received from the source (step 3b), and

the router RM routes the duplicated IP packets to the terminal Ti via the Internet (step 3c).

Remember that the expression “multicast router” refers to a node of the network that receives the IP packets broadcast by the source and routes them to one or more terminals, where applicable after duplicating them, if necessary.

In a step 4, on receiving the first IP data packet broadcast by the source S, the terminal Ti sends the collection server SC an audience report via the Internet. This first report informs the server SC that the terminal Ti has just begun to receive from the source S. It contains information relative to the receiver terminal Ti, in this case a geographical indication of the location of the terminal Ti, the preferred language of the terminal Ti, the bit rate at which the terminal Ti is receiving and the rate of loss of IP packets received. The terminal Ti repeats step 4 periodically, at a frequency 1/τ, so as to indicate to the server SC that it is receiving from the source S, until it interrupts the reception of IP packets broadcast by the source S. Before interrupting reception, if it has the capability to do so, the terminal Ti sends a last audience report informing the server SC that it is about to cease receiving.

The server SC receives the audience reports from all the terminals Ti of the multicast group of terminals receiving from the broadcast source S, and assigns a time and a date to each report received (step 5). The expression “multicast group” refers to all the terminals receiving from a given multicast broadcast source.

In a step 6, based on the audience reports from the terminals Ti receiving from the broadcast source S, the server SC generates a statistical summary concerning the audience of said broadcast source S. The audience summary contains an audience histogram showing, up the ordinate axis, the number of terminals receiving from the broadcast source S, and along the abscissa axis, the receiving time and date, together with various histograms concerning preferred languages, reception quality, and the locations of the terminals receiving from the broadcast source S. It then transmits the audience summary relating to the source S to the programming center CP.

In a step 7, by taking account of the audience summary, the programming center CP modifies the programming schedule of the source S so as to adapt to the audiovisual profiles of the receiver terminals Ti. The center CP can thus change the times at which certain audiovisual contents, e.g. advertising, are broadcast, thereby targeting more precisely the audience likely to be interested by said contents.

In a step 8, to reduce the number of reports received, the server SC transmits to the terminals Ti a command to modify the period for sending audience reports, indicating a new period τ′ greater than the period τ. On receiving this command, each terminal Ti replaces the old period τ in its memory with the new period τ′. In the same way, the server SC could reduce the period for sending audience reports, in order to receive more reports.

The collection server SC can be used by a plurality of broadcast sources S. In this case, because the sources S broadcast contents to various multicast groups of receiver terminals, all the receiver terminals belonging to the various multicast groups send their audience reports to the same collection server SC. The latter then produces different individualized audience summaries concerning the respective different broadcast sources. In other words, the collection server produces an audience summary for each of the broadcast sources S. It then transmits the audience summary relating to each broadcast source S to the programming center CP from which said broadcast source S depends.

In the foregoing description, the descriptive data associated with the source S is inserted into an SDP file and the receiver terminals Ti recover the SDP file by downloading it from a website SW. The terminals could recover the descriptive data associated with the source by any other means. For example, the descriptive data could be inserted into an electronic mail sent to the terminal Ti.

In a different implementation of the invention, the characteristics of the collection server are broadcast on a signaling channel associated with the source. In this case, if a terminal wishes to receive the content broadcast by the broadcast source, it first recovers the information needed to receive the signaling channel associated with the source, for example by downloading it from a website, and then receives the signaling channel in order to acquire the descriptive data associated with the source, containing information needed to receive from the source, as well as the characteristics of the collection server contained in the field “d” previously described.

The descriptive file containing all the information required to received from the source, could have a format other than the SDP format, for example the XML format file.

The invention can be applied to the broadcasting of multimedia content other than audiovisual content, and via a computer network other than the Internet. It can also be applied to unicast broadcasting.

1. A method of broadcasting a content from a broadcast source (S) to a plurality of receiver terminals (Ti) via a computer network and in real time, in which method each terminal (Ti) recovers descriptive data associated with the source (S), the source (S) broadcasts the content over the network, and the receiver terminals (Ti) acquire the broadcast content, using said descriptive data, which method is characterized in that an address of a collection server (SC) is inserted into said descriptive data and, using said descriptive data, each receiver terminal (Ti) signals that it is receiving from the broadcast source (S) by sending an audience report to said address.

2. A method according to claim 1, wherein periodicity information is inserted into said descriptive data so that each receiver terminal (Ti) can periodically send the collection server (SC) an audience report indicating that it is receiving from the broadcast source (S).

3. A method according to claim 1, wherein each terminal (Ti) inserts into the audience report a geographical location indication and/or a preferred language and/or information about reception quality.

4. A method according to claim 1, wherein the collection server (SC) assigns a time and a date to each audience report received.

5. A method according to claim 1, wherein the collection server (SC) responds to audience reports from the terminals (Ti), to produce a summary concerning the audience of the broadcast source (S) indicating the number of terminals receiving from the broadcast source (S).

6. A method according to claim 1, wherein a plurality of sources broadcast contents to a plurality of groups of receiver terminals (Ti) and all the terminals belonging to the various groups send audience reports to the same collection server (SC).

7. A method according to claim 1, wherein an indication of the network of the collection server (SC) and/or the collection server (SC) address type and/or a reception report receiver port indication is/are also inserted into said descriptive.

8. A method according to claim 1, wherein the collection server (SC) transmits new periodicity information to the receiver terminals (Ti) to modify the period for sending audience reports.

9. A method according to claim 1, wherein the descriptive data associated with the source is inserted into an SDP file.

10. A method according to claim 1, wherein the address of the collection server is broadcast on a signaling channel associated with the source.

11. A collection server for implementing the method according to claim 1, comprising:
receiver means (91) adapted to receive from receiver terminals (Ti) audience reports concerning a broadcast source (S) and indicating that said terminals (Ti) are receiving from said broadcast source (S),
processor means (92) adapted to respond to audience reports it receives, to produce a summary relating to the audience of said broadcast source and indicating the number of terminals (Ti) receiving from said broadcast source (S), and
means (93) for sending the audience summary to a programming center (CP) associated with said source (S).

12. A server according to claim 11, including means (92) for dating and timing audience reports.

13. A server according to claim 11, including means (95) for modifying the period for sending reception reports.

14. A receiver terminal for implementing a method according to claim 1, characterized in that it is adapted to recover descriptive data associated with a broadcast source (S) and containing an address of a collection server (S) and to send to the address of said collection server (SC) at least one audience report indicating that it is receiving from said broadcast source (S).

15. A terminal according to claim 14, characterized in that it is adapted to send periodically to the address of the collection server (SC) a plurality of audience reports.

16. A system for implementing the method according to claim 1, the system comprising:
a broadcast source (S) adapted to broadcast a content over a network,
a collection server (SC), and
receiver terminals (Ti) adapted to recover descriptive data associated with the broadcast source (S) and containing an address of the collection server (SC), to acquire the content broadcast by the broadcast source (S) using the descriptive data, and to send to the address of the collection server (SC) audience reports indicating that the terminals are receiving from said broadcast source (S),
said collection server (SC) being adapted to produce a summary on the audience of said broadcast source (S) indicating the number of terminals (Ti) receiving from said broadcast source (S).

17. A system according to claim 13, wherein the receiver terminals (Ti) are adapted to send audience reports periodically to the collection server (SC) and said collection server (SC) includes means (95) for modifying the period for sending audience reports.

18. A descriptive data stream for implementing the method according to claim 1 and containing information to enable a terminal (Ti) to receive from a broadcast source (S), characterized in that it contains information enabling the terminal (Ti) to send to a collection server (SC) an audience report indicating that it is receiving from said broadcast source (S).

19. A data stream according to claim 18, characterized in that it contains a network address of the collection server (SC).

20. A data stream according to claim 19, characterized in that it also contains an indication of the network to which the collection server (SC) belongs and/or the collection server (SC) address type and/or the number of a communication port of the collection server (SC) and/or a period for sending audience reports to the collection server (SC).

21. A data stream according to claim 18, wherein the descriptive data is to the SDP format.
